(19) United States
(12) Patent Application Publication
(10) Pub. No.: US 2025/0240528 A1
(43) Pub. Date: Jul. 24, 2025

(54) REFLECTION MODULE AND CAMERA MODULE INCLUDING THE SAME

(71) Applicant: SAMSUNG ELECTRO-MECHANICS CO., LTD., Suwon-si (KR)

(72) Inventors: Young Hwan KWON, Suwon-si (KR); Young Bok YOON, Suwon-si (KR); Jae Hyung HAN, Suwon-si (KR)

(73) Assignee: SAMSUNG ELECTRO-MECHANICS CO., LTD., Suwon-si (KR)

(21) Appl. No.: 19/049,207

(22) Filed: Feb. 10, 2025

Related U.S. Application Data
(63) Continuation-in-part of application No. 19/007,886, filed on Jan. 2, 2025.

(30) Foreign Application Priority Data
Jan. 24, 2024 (KR) 10-2024-0010855
Oct. 22, 2024 (KR) 10-2024-0145290

(51) Int. Cl. H04N 23/68; H04N 23/55; H04N 23/57

(52) U.S. Cl. CPC H04N 23/687; H04N 23/55; H04N 23/57

(57) ABSTRACT

A reflection module includes a housing, a guide member disposed to be relatively rotatable on the housing, based on a first rotation axis, and a holder disposed to be relatively rotatable on the guide member based on a second rotation axis and having a reflection member mounted therein, wherein a first pulling magnet is disposed on one of the guide member and the holder, a second pulling magnet facing the first pulling magnet is disposed on the other of the guide member and the holder, and both attractive force and repulsive force are applied between the first pulling magnet and the second pulling magnet.

### CROSS-REFERENCE TO RELATED APPLICATIONS

This application is a continuation-in-part of U.S. patent application Ser. No. 19/007,886 filed on Jan. 2, 2025, which claims the benefit under 35 USC 119(a) of Korean Patent Application Nos. 10-2024-0010855 filed on Jan. 24, 2024, and 10-2024-0145290 filed on Oct. 22, 2024, in the Korean Intellectual Property Office, the entire disclosures of which are incorporated herein by reference for all purposes.

### BACKGROUND

### 1. Field

The present disclosure relates to a reflection module and a camera module including the same.

### 2. Description of the Background

A camera module may have a device to bend a path of light, for example, a reflection member (prism, mirror) in front of a lens module may be adopted in a camera module of a mobile device.

Additionally, the camera module may have a shake correction function that compensates for shaking when capturing an image to increase resolution. This shake correction function may be implemented through two-axis rotation of the reflection member.

In this case, since the reflection member is disposed in a rotatable state, there may be a problem that the reflection member tilts to one side when the camera module is turned off.

Furthermore, a plurality of drivers may be required for the two-axis rotation of the reflection member, but the structure of the plurality of drivers may be complex, which may increase the size and weight thereof.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflection module includes a housing, a guide member disposed to be relatively rotatable on the housing, based on a first rotation axis, and a holder disposed to be relatively rotatable on the guide member based on a second rotation axis and having a reflection member mounted therein, wherein a first pulling magnet is disposed on one of the guide member and the holder, and a second pulling magnet facing the first pulling magnet is disposed on the other of the guide member and the holder, and both attractive force and repulsive force are applied between the first pulling magnet and the second pulling magnet.

One surface of the first pulling magnet and one surface of the second pulling magnet may face each other, and a number of polarities of the one surface of the first pulling magnet and a number of polarities of the one surface of the second pulling magnet may be different from each other.

An area in which opposite polarities face each other may be greater than an area in which same polarities face each other, on the one surface of the first pulling magnet and the one surface of the second pulling magnet.

A magnitude of the attractive force may be greater than a magnitude of the repulsive force.

One surface of the first pulling magnet and one surface of the second pulling magnet may face each other, the one surface of the first pulling magnet may have one polarity, and the one surface of the second pulling magnet may have a plurality of polarities including opposite polarities.

The one surface of the second pulling magnet may have two first polarities spaced apart from each other and a second polarity disposed between the two first polarities, the first polarity may be a same polarity as the one polarity of the one surface of the first pulling magnet, and the first polarity and the second polarity may be opposite polarities.

A length of the second polarity may be equal to or longer than a sum of lengths of the two first polarities, and the length may be a length in a direction of the first rotation axis.

A boundary region between the plurality of polarities may be parallel to the second rotation axis.

Among the first pulling magnet and the second pulling magnet, a length of the pulling magnet mounted on the holder may be equal to or longer than a length of the pulling magnet mounted on the guide member, and the length may be a length in a direction of the first rotation axis.

The first pulling magnet may include a first-first pulling magnet and a first-second pulling magnet spaced apart from each other in a direction of the first rotation axis, the second pulling magnet may include a second-first pulling magnet facing the first-first pulling magnet and a second-second pulling magnet facing the first-second pulling magnet, both attractive force and repulsive force may be applied between the first-first pulling magnet and the second-first pulling magnet, and both attractive forces and repulsive forces may be applied between the first-second pulling magnet and the second-second pulling magnet.

A number of polarities of one surface of the first-first pulling magnet and a number of polarities of one surface of the second-first pulling magnet facing each other may be different from each other, and a number of polarities of one surface of the first-second pulling magnet and a number of polarities of one surface of the second-second pulling magnet facing each other may be different from each other.

The one surface of the first-first pulling magnet and the one surface of the first-second pulling magnet may have a first polarity and a second polarity, respectively, and the one surface of the second-first pulling magnet and the one surface of the second-second pulling magnet may have a first polarity or a second polarity, respectively, and the first polarity and the second polarity may be opposite polarities.

Among the first polarity and the second polarity of the one surface of the first-first pulling magnet, a length of a polarity disposed closer to the second rotation axis may be equal to or longer than a length of the other polarity, among the first polarity and the second polarity of the one surface of the first-second pulling magnet, a length of a polarity disposed closer to the second rotation axis may be equal to or longer than a length of the other polarity, and the length may be a length in a direction of the first rotation axis.

A first ball member including a plurality of balls may be disposed between the guide member and the holder, and the plurality of balls may be spaced apart from each other in a direction of the second rotation axis.

The reflection module may further include a first driver including a first magnet disposed in the holder and a first coil facing the first magnet, wherein the first magnet may include two magnets, and the two magnets may be disposed separately on one surface and another surface of the holder spaced apart from each other in a direction of the first rotation axis, the first driver may be spaced apart from the first rotation axis in a direction of the second rotation axis, and the first driver may be spaced apart from the second rotation axis in a direction of the first rotation axis.

In another general aspect, a camera module includes a housing, a guide member disposed to be relatively rotatable on the housing, based on a first rotation axis, a holder disposed to be relatively rotatable on the guide member based on a second rotation axis and having a reflection member mounted therein, and a first driver including a first magnet disposed in the holder and a first coil facing the first magnet, wherein the first magnet includes two magnets, and the two magnets are disposed separately on one surface and another surface of the holder, which are spaced apart from each other in a direction of the first rotation axis, the first driver is spaced apart from the first rotation axis in a direction of the second rotation axis, and the first driver is spaced apart from the second rotation axis in the direction of the first rotation axis.

The camera module may further include a first lens module having a first optical axis and coupled to the holder, wherein the first optical axis may be perpendicular to the first rotation axis and the second rotation axis.

A first pulling magnet may be disposed in one of the guide member and the holder, a second pulling magnet facing the first pulling magnet may be disposed in the other one of the guide member and the holder, one surface of the first pulling magnet and one surface of the second pulling magnet may face each other, and a number of polarities of the one surface of the first pulling magnet may be different from a number of polarities of the one surface of the second pulling magnet.

A first ball member including a plurality of balls may be disposed between the guide member and the holder, and the plurality of balls of the first ball member may be spaced apart from each other in the direction of the second rotation axis, and a second ball member including a plurality of balls may be disposed between the guide member and the housing, and the plurality of balls of the second ball member may be spaced apart from each other in the direction of the first rotation axis.

A virtual line connecting the plurality of balls of the first ball member in the direction of the second rotation axis may be spaced apart from the first magnet in the direction of the first rotation axis, and a virtual line connecting the plurality of balls of the second ball member in the direction of the first rotation axis may be spaced apart from the first magnet in the direction of the second rotation axis.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIGS. 2 and 3 are partially cut-away perspective views of a camera module according to an example embodiment of the present disclosure.

FIG. 4 is an exploded perspective view of a camera module according to an example embodiment of the present disclosure.

FIG. 5 is an exploded perspective view of a reflection module and a housing.

FIG. 6 is a bottom perspective view of a guide member of the reflection module.

FIG. 7 is a partially exploded perspective view of the reflection module.

FIG. 8 is a plan view of the guide member.

FIG. 9 is a bottom view of the guide member.

FIG. 10 is a plan view of a holder and a reflection member.

FIG. 11 is a bottom view of the holder.

FIG. 12 is a cross-sectional view of a first pulling magnet and a second pulling magnet.

FIGS. 13A and 13B are views illustrating attractive force and repulsive force acting between a first pulling magnet and a second pulling magnet.

FIG. 14 is a plan view of a guide member and a second pulling magnet according to another example embodiment.

FIG. 15 is a bottom view of a holder and a third pulling magnet according to another example embodiment.

FIG. 16 is a cross-sectional view of a second pulling magnet and a third pulling magnet according to another example embodiment.

FIG. 17 is a perspective view of the reflection module and the first lens module.

FIG. 18 is a bottom perspective view of the reflection module and the first lens module.

FIG. 19 is a perspective view of a first driver, a first ball member and a second ball member according to an example embodiment of the present disclosure.

FIG. 20 is a plan view of a housing according to an example embodiment of the present disclosure.

FIG. 21 is a perspective view illustrating a state in which a second lens module is separated from a camera module according to an example embodiment of the present disclosure.

FIG. 22 is a bottom perspective view of the second lens module.

FIG. 23 is an exploded perspective view of a camera module according to another example embodiment of the present disclosure.

FIG. 24 is an exploded perspective view of a camera module viewed from a direction different from that of FIG. 23.

FIG. 25 is a bottom perspective view of a reflection module according to another example embodiment of the present disclosure.

FIG. 26 is a perspective view of a reflection module and a first lens module according to another example embodiment of the present disclosure.

FIG. 27 is a perspective view of a first driver, a first ball member, a second ball member, a first pulling magnet and a second pulling magnet according to another example embodiment of the present disclosure.

FIG. 28 is a block diagram illustrating a configuration of a first driver and a position sensing unit according to an example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide a reflection module and camera module including the same so that a reflection member may be disposed in an original position thereof when power is not applied.

An aspect of the present disclosure may provide a reflection module and camera module including the same to simplify a structure of a driver for shake correction.

The present disclosure relates to a reflection module and a camera module including the same, and the camera module may be mounted on a portable electronic device such as a mobile communication terminal, a smartphone, or a tablet PC.

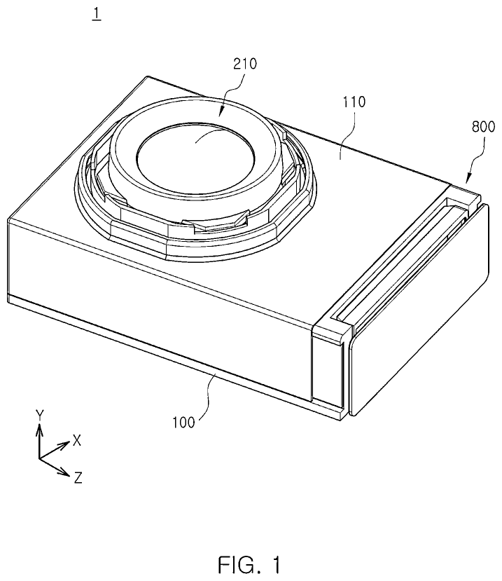

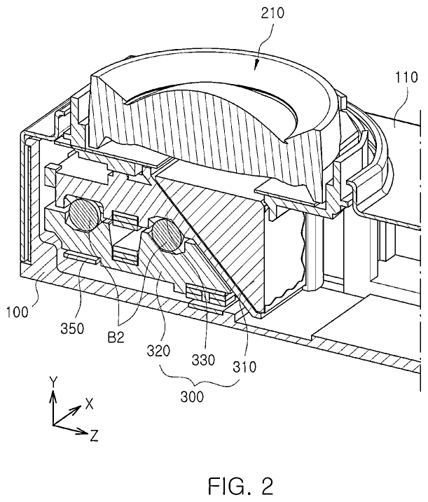

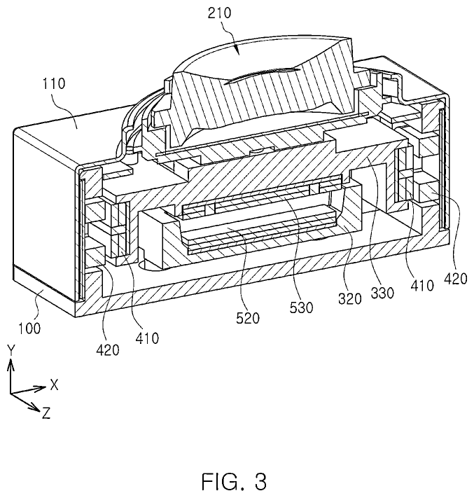

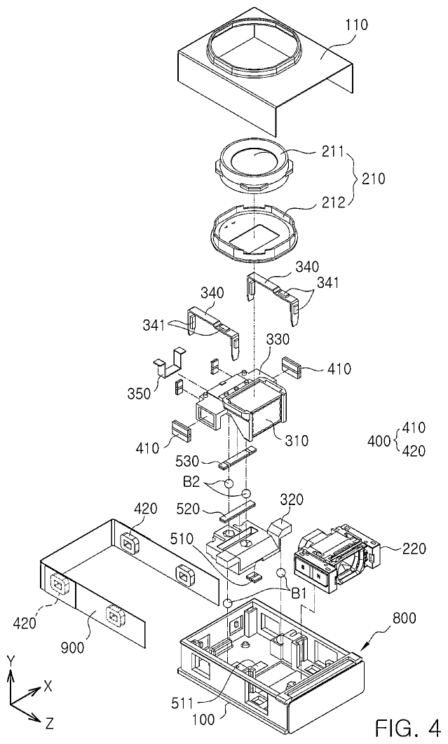

FIG. 1 is a perspective view of a camera module according to an example embodiment of the present disclosure, FIGS. 2 and 3 are partially cut-away perspective views of a camera module according to an example embodiment of the present disclosure, and FIG. 4 is an exploded perspective view of a camera module according to an example embodiment of the present disclosure.

Referring to FIGS. 1 to 4, a camera module 1 according to an example embodiment of the present disclosure includes a reflection module 300 and a housing 100.

The reflection module 300 may be disposed in the housing 100 and include a reflection member 310 having a reflection surface.

The reflection module 300 may be disposed so as to be rotatable about two different axes for shake correction. For example, the reflection module 300 may be rotatable about two axes, perpendicular to each other, in the housing 100.

In an example embodiment, a camera module 1 may further include a first lens module 210.

The first lens module 210 includes at least one lens, and the at least one lens has a first optical axis (Y-axis). The first optical axis (Y-axis) may extend in a vertical direction based on FIG. 4. The first optical axis (Y-axis) may pass through a center of the at least one lens of the first lens module 210.

In an example embodiment, the first lens module 210 includes a first lens barrel 211 and a first lens holder 212. At least one lens may be disposed in the first lens barrel 211, and the first lens barrel 211 may be coupled to the first lens holder 212. The first lens holder 212 may be coupled to the reflection module 300. Alternatively, the first lens module 210 may include only the first lens barrel 211 without including the first lens holder 212, and the first lens barrel 211 may be coupled to the reflection module 300.

The first lens module 210 may be disposed in front of the reflection module 300. Here, ‘front’ may refer to a positive first optical axis (Y-axis) direction (+Y-axis direction) based on the reflection module 300. For example, the first lens module 210 may be disposed above the reflection module 300 in the first optical axis (Y-axis) direction.

The first lens module 210 may be coupled to the reflection module 300. For example, the first lens holder 212 of the first lens module 210 may be coupled to a holder 330 of the reflection module 300.

The first lens module 210 and the reflection module 300 are disposed in the housing 100.

In an example embodiment, the camera module 1 may further include a second lens module 220. The reflection module 300 is disposed between the first lens module 210 and the second lens module 220. The second lens module 220 includes a plurality of lenses and has a second optical axis (Z-axis). The plurality of lenses are disposed along the second optical axis (Z-axis). The second optical axis (Z-axis) may pass through a center of the plurality of lenses of the second lens module 220.

The first optical axis (Y-axis) of the first lens module 210 and the second optical axis (Z-axis) of the second lens module 220 may be formed to be perpendicular to each other.

The first lens module 210 includes one or more lenses, and the second lens module 220 includes a plurality of lenses.

One or more lenses of the first lens module 210 may be circular when viewed in the first optical axis (Y-axis) direction. At least one lens of the plurality of lenses of the second lens module 220 may be non-circular when viewed in the second optical axis (Z-axis) direction. For example, the non-circular lens may have different lengths in two directions, perpendicular to the second optical axis (Z-axis) direction, and perpendicular to each other. In an example embodiment, in the non-circular lens, a length thereof in the first (X-axis) direction, perpendicular to both the first optical axis (Y-axis) direction and the second optical axis (Z-axis) direction, is longer than a length thereof in the first optical axis (Y-axis) direction.

The first lens module 210 and the reflection module 300 may be configured to rotate together for shake correction. The second lens module 220 may be moved in the second optical axis (Z-axis) direction for focus adjustment.

The camera module 1 may further include an image sensor module 800.

The image sensor module 800 includes a sensor housing, an image sensor, and a printed circuit board, and may further include an infrared cutoff filter.

The infrared cutoff filter (infrared blocking filter) may be mounted on the sensor housing. The infrared blocking filter serves to block light in the infrared region, among the light passing through the second lens module, from reaching the image sensor.

The printed circuit board is coupled with the sensor housing, and the image sensor is disposed on the printed circuit board.

The light passing through the second lens module 220 is received by the image sensor module 800 (e.g., an image sensor).

The camera module 1 may further include a case 110. The case 110 is coupled with the housing 100 so as to cover an upper portion of the housing 100. The case 110 may include an opening, and the first lens module 210 may be disposed in the opening.

Meanwhile, at least a portion of the first lens module 210 may be disposed to protrude outside the housing 100 and the case 110.

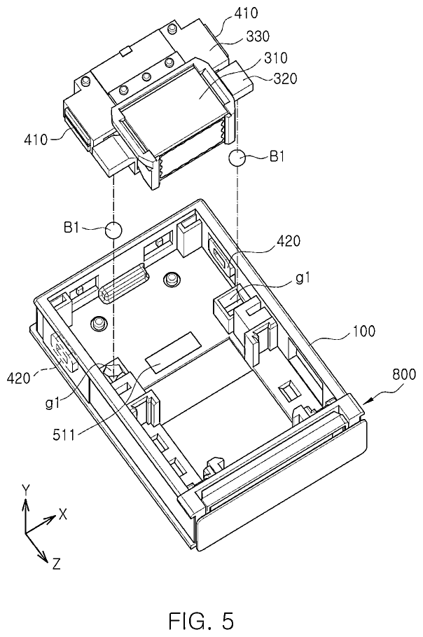

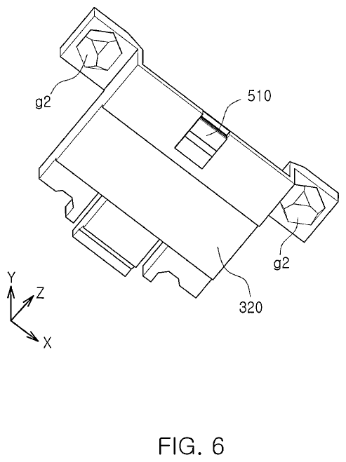

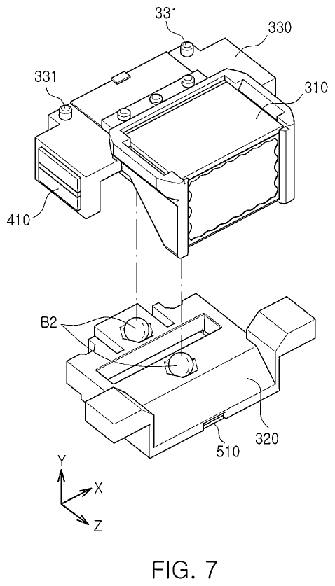

FIG. 5 is an exploded perspective view of a reflection module and a housing, FIG. 6 is a bottom perspective view of a guide member of the reflection module, and FIG. 7 is a partially exploded perspective view of the reflection module.

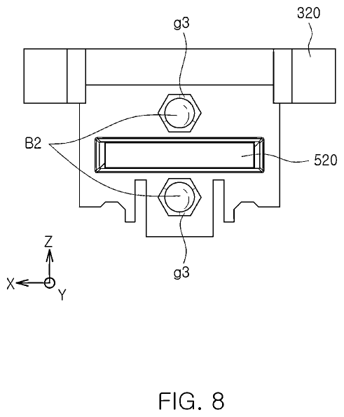

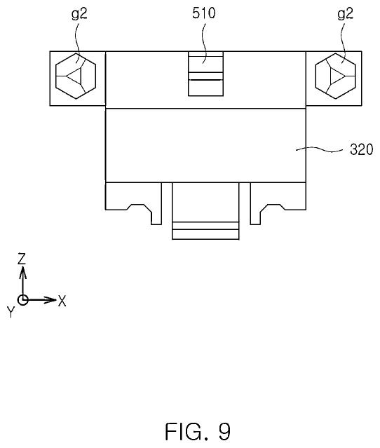

Additionally, FIG. 8 is a plan view of a guide member, and FIG. 9 is a bottom view of the guide member.

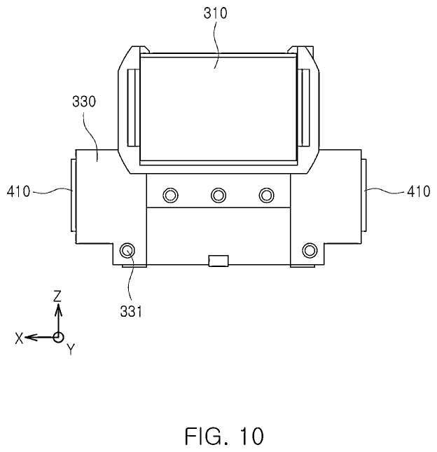

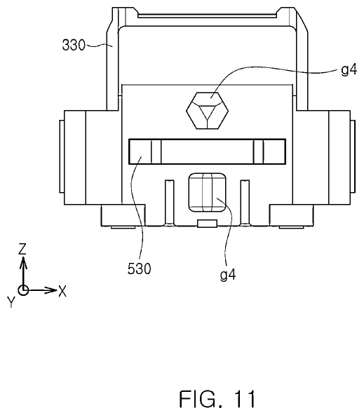

Additionally, FIG. 10 is a plan view of a holder and a reflection member, and FIG. 11 is a bottom view of the holder.

Referring to FIGS. 5 to 11, a reflection module 300 includes a reflection member 310, a holder 330, and a guide member 320.

The reflection member 310 has a reflection surface that reflects light passing through the first lens module 210. For example, the reflection member 310 may be a prism or a mirror.

When the reflection member 310 is a prism, the reflection member 310 may be any shape obtained by dividing a rectangular solid (or a cube) into two halves in a diagonal direction. The prism includes an incident surface on which light is incident, a reflection surface that reflects light passing through the incident surface, and an exit surface from which light reflected from the reflection surface is emitted.

The reflection member 310 is mounted on a holder 330. The first lens module 210 may be arranged in front of the reflection member 310. In an example embodiment, the first lens module 210 may be mounted on the holder 330.

The holder 330 is rotatably disposed on the guide member 320. Additionally, the guide member 320 is rotatably disposed on the housing 100.

The guide member 320 may be rotatable about the first axis (X-axis), perpendicular to both the first optical axis (Y-axis) and the second optical axis (Z-axis), as a rotation axis. For example, the guide member 320 may be relatively rotatable on the housing 100 about the first axis (X-axis) as the rotation axis. In this case, the first lens module 210 and the holder 330 may also be rotated together with the guide member 320. Meanwhile, the first axis (X-axis) may also be referred to as a first rotation axis.

The holder 330 may be rotatable about the second optical axis (Z-axis), perpendicular to the first axis (X-axis), as the rotation axis. For example, the holder 330 may be relatively rotatable on the guide member 320 about the second optical axis (Z-axis) as the rotation axis. In this case, the first lens module 210 may be rotated together with the holder 330. Meanwhile, the second optical axis (Z-axis) may also be referred to as a second rotation axis.

A first driver 400 may be provided to rotate the reflection module 300. The first driver 400 includes a first magnet 410 and a first coil 420. The guide member 320 may be relatively rotatable on the housing 100 based on the first axis (X-axis) by the first driver 400. Since the holder 330 and the first lens module 210 are disposed on the guide member 320, the holder 330 and the first lens module 210 may also be rotated together with the guide member 320.

The first magnet 410 may be mounted on the holder 330. For example, the first magnet 410 may be mounted on a side surface of the holder 330. The side surface of the holder 330 may refer to one surface of the holder 330 facing the housing 100 in the first axis (X-axis) direction.

The first magnet 410 may be magnetized so that one surface (e.g., a surface facing the first coil 420) has both an N-pole and an S-pole. In an example embodiment, the surface of the first magnet 410 facing the first coil 420 may be provided with an N-pole, a neutral region, and an S-pole sequentially in the first optical axis (Y-axis) direction.

The first coil 420 may be disposed to face the first magnet 410. In an example embodiment, the first coil 420 may be disposed to face the first magnet 410 in the first axis (X-axis) direction.

The first coil 420 is disposed on a substrate 900, and the substrate 900 is mounted on the housing 100 so that the first magnet 410 and the first coil 420 face each other in the first axis (X-axis) direction.

The housing 100 is provided with a through-hole penetrating through the housing 100 in a first axis (X-axis) direction, and the first coil 420 is disposed in the through-hole so as to directly face the first magnet 410.

When the shake correction is performed, the first magnet 410 is a movable member that is mounted on the holder 330 and rotates, and the first coil 420 is a fixed member fixed to the substrate 900.

When power is applied to the first driver 400, the first driver 400 may generate driving force required for rotation of the holder 330 and the guide member 320 with the first axis (X-axis) as the rotation axis. For example, the first driver 400 may generate driving force in the first optical axis (Y-axis) direction.

The first magnet 410 may include a plurality of magnets. In an example embodiment, the first magnet 410 may include two magnets spaced apart from each other. The two magnets of the first magnet 410 may be spaced apart from each other in the first axis (X-axis) direction.

One of the two magnets of the first magnet 410 may be disposed on one side surface of the holder 330, and the other thereof may be disposed on another side surface of the holder 330. The one side surface of the holder 330 and the other side surface of the holder 330 may be spaced apart from each other in the first axis (X-axis) direction.

The first coil 420 may include a plurality of coils. In an example embodiment, the first coil 420 may include two coils spaced apart from each other. The two coils of the first coil 420 may be spaced apart from each other in the first axis (X-axis) direction.

In an example embodiment, a pair of magnets and coils may be disposed on one side of the reflection module 300, and the other pair of magnets and coils may be disposed on the other side of the reflection module 300.

When the guide member 320 and the holder 330 are rotated about the first axis (X-axis) as the rotation axis, a direction of driving force of the one pair of magnets and coils and a direction of driving force of the other pair of magnets and coils may be the same.

For example, when the direction of the driving force of the one pair of magnets and coils is a positive first optical axis (Y-axis) direction (+Y-axis direction) and the direction of the driving force of the other pair of magnets and coils is also the positive first optical axis (Y-axis) direction (+Y-axis direction), the guide member 320 and the holder 330 may be rotated together based on the first axis (X-axis).

Additionally, when the direction of the driving force of the one pair of magnets and coils is a negative first optical axis (Y-axis) direction (−Y-axis direction) and the direction of the driving force of the other pair of magnets and coils is also the negative first optical axis (Y-axis) direction (−Y-axis direction), the guide member 320 and the holder 330 may be rotated together based on the first axis (X-axis).

A first ball member B1 may be disposed between the guide member 320 and the housing 100. The first ball member B1 may be disposed between the guide member 320 and the housing 100 to form a rotation axis of the guide member 320.

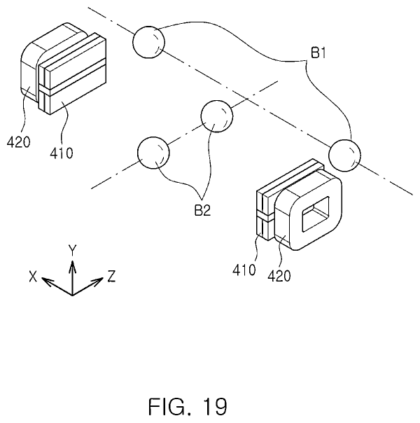

The first ball member B1 includes a plurality of balls spaced apart from each other in the first axis (X-axis) direction. A virtual line connecting the plurality of balls of the first ball member B1 in the first axis (X-axis) direction may be spaced apart from the first magnet 410 in the second optical axis (Z-axis) direction (see FIG. 19).

In an example embodiment, the first magnet 410 and the first coil 420 may be spaced apart from the first ball member B1 in the second optical axis (Z-axis) direction. When driving force is generated in the first optical axis (Y-axis) direction by the first magnet 410 and the first coil 420, the holder 330 may be rotated based on the rotation axis formed by the first ball member B1. Since the holder 330 is disposed on the guide member 320, the holder 330 and the guide member 320 may be rotated together based on the first axis (X-axis) by the first driver 400.

The virtual line connecting the plurality of balls of the first ball member B1 in the first axis (X-axis) direction may pass through a reflection surface of the first reflection member 310.

In an example embodiment, when viewed from the first axis (X-axis) direction, a line extending the first optical axis (Y-axis) of the first lens module 210 may be disposed between both ends of the plurality of balls of the first ball member B1. Here, the both ends of the plurality of balls of the first ball member B1 may refer to both ends in the second optical axis (Z-axis) direction.

Attractive force may be applied between the guide member 320 and the housing 100. For example, a first pulling magnet 510 may be disposed on one of the guide member 320 and the housing 100, and a first pulling yoke 511 may be disposed on the other thereof.

In an example embodiment, the first pulling magnet 510 may be disposed on a lower surface of the guide member 320, and the first pulling yoke 511 may be disposed on a bottom surface of the housing 100.

The first pulling magnet 510 and the first pulling yoke 511 may face each other in the first optical axis (Y-axis) direction.

The first pulling magnet 510 and the first pulling yoke 511 may generate attractive force between each other. For example, the first pulling yoke 511 may be formed of a magnetic material. The attractive force may be applied between the first pulling magnet 510 and the first pulling yoke 511 in the first optical axis (Y-axis) direction.

By the attractive force between the first pulling magnet 510 and the first pulling yoke 511, the first ball member B1 may remain in contact with the guide member 320 and the housing 100, respectively.

A first guide groove g1 and a second guide groove g2 may be disposed on surfaces on which the guide member 320 and the housing 100 face each other (for example, surfaces facing each other in the first optical axis (Y-axis) direction). For example, the first guide groove g1 may be disposed on the housing 100, and the second guide groove g2 may be disposed on the guide member 320. The first guide groove g1 and the second guide groove g2 may face each other in the first optical axis (Y-axis) direction.

The first guide groove g1 includes a plurality of grooves spaced apart from each other in the first axis (X-axis) direction, and the second guide groove g2 includes a plurality of grooves spaced apart from each other in the first axis (X-axis) direction.

The first ball member B1 may be disposed between the first guide groove g1 and the second guide groove g2 to form a rotation axis of the guide member 320.

One of a plurality of grooves of the first guide groove g1 may be in three-point contact with the first ball member B1, and another of the plurality of grooves of the first guide groove g1 may be in two-point contact with the first ball member B1. For example, referring to FIG. 5, a groove disposed on the left side, among the plurality of grooves of the first guide groove g1, may be in three-point contact with the first ball member B1, and a groove disposed on the right side, among the plurality of grooves of the first guide groove g1, may be in two-point contact with the first ball member B1.

Additionally, each of the plurality of grooves of the second guide groove g2 may be in three-point contact with the first ball member B1. A shape of the first guide groove g1 and a shape of the second guide groove g2 may be reversed from each other.

The first driver 400 may rotate the holder 330 based on the second optical axis (Z-axis). That is, the holder 330 may be rotated based on the second optical axis (Z-axis) by the first driver 400. Since the first lens module 210 is disposed on the holder 330, the first lens module 210 may also be rotated together with the holder 330.

When power is applied to the first driver 400, the first driver 400 may generate driving force required for rotation of the holder 330 with the second optical axis (Z axis) as a rotation axis. For example, the first driver 400 may generate driving force in the first optical axis (Y-axis) direction.

In an example embodiment, when the holder 330 is rotated about the second optical axis (Z-axis) as the rotation axis, the direction of the driving force of the one pair of magnets and coils and the direction of the driving force of the other pair of magnets and coils may be opposite to each other.

For example, when the direction of the driving force of the one pair of magnets and coils is a positive first optical axis (Y-axis) direction (+Y-axis direction) and the direction of the driving force of the other pair of magnets and coils is a negative first optical axis (Y-axis) direction (−Y-axis direction), the holder 330 may be rotated based on the second optical axis (Z-axis).

Additionally, when the direction of the driving force of the one pair of magnets and coils is the negative first optical axis (Y-axis) direction (−Y-axis direction) and the direction of the driving force of the other pair of magnets and coils is the positive first optical axis (Y-axis) direction (+Y-axis direction), the holder 330 may be rotated based on the second optical axis (Z-axis).

Additionally, the holder 330 may also be rotated in a diagonal direction. For example, the guide member 320 and the holder 330 may be rotatable based on the first axis (X-axis) and the holder 330 may be rotatable based on the second optical axis (Z-axis), thereby rotating the holder 330 in the diagonal direction.

In an example embodiment, the driving force may be generated only from the one pair of magnets and coils and the driving force may not be generated from the other pair of magnets and coils, so that the holder 330 may be rotated in the diagonal direction. Alternatively, a size (and/or direction) of the driving force of the one pair of magnets and coils may be generated differently from a size (and/or direction) of the driving force of the other pair of magnets and coils, so that the holder 330 may be rotated in the diagonal direction.

A second ball member B2 may be disposed between the holder 330 and the guide member 320. The second ball member B2 may be disposed between the holder 330 and the guide member 320 to form a rotation axis of the holder 330.

The second ball member B2 includes a plurality of balls spaced apart from each other in the second optical axis (Z-axis) direction. A virtual line connecting the plurality of balls of the second ball member B2 in the second optical axis (Z-axis) direction may be spaced apart from the first magnet 410 in the first axis (X-axis) direction (see FIG. 19).

In an example embodiment, the first magnet 410 and the first coil 420 may be spaced apart from the second ball member B2 in the first axis (X-axis) direction. When the driving force is generated in the first optical axis (Y-axis) direction by the first magnet 410 and the first coil 420, the holder 330 may be rotated based on the rotation axis formed by the second ball member B2.

The virtual line connecting the plurality of balls of the second ball member B2 in the second optical axis (Z-axis) direction may pass through the reflection surface of the first reflection member 310.

In an example embodiment, when viewed from the first axis (X-axis) direction, a line extending the second optical axis (Z-axis) of the second lens module 220 may be disposed between both ends of the plurality of balls of the second ball member B2. Here, the both ends of the plurality of balls of the second ball member B2 may refer to both ends in the first optical axis (Y-axis) direction.

A third guide groove g3 and a fourth guide groove g4 may be disposed on surfaces on which the holder 330 and the guide member 320 face each other (for example, surfaces facing each other in the first optical axis (Y-axis) direction). For example, the third guide groove g3 may be disposed in the guide member 320, and the fourth guide groove g4 may be disposed in the holder 330. The third guide groove g3 and the fourth guide groove g4 may face each other in the first optical axis (Y-axis) direction.

The third guide groove g3 includes a plurality of grooves spaced apart from each other in the second optical axis (Z-axis) direction, and the fourth guide groove g4 includes a plurality of grooves spaced apart from each other in the second optical axis (Z-axis) direction.

The second ball member B2 may be disposed between the third guide groove g3 and the fourth guide groove g4 to form a rotational axis of the holder 330.

One of a plurality of grooves of the fourth guide groove g4 may be in three-point contact with the second ball member B2, and another of the plurality of grooves of the fourth guide groove g4 may be in two-point contact with the second ball member B2. For example, referring to FIG. 11, a groove disposed in an upper portion, among the plurality of grooves of the fourth guide groove g4, may be in three-point contact with the second ball member B2, and a groove disposed in a lower portion, among the plurality of grooves of the fourth guide groove g4, may be in two-point contact with the second ball member B2.

Additionally, a plurality of grooves of the third guide groove g3 may be in three-point contact with the second ball member B2. A shape of the third guide groove g3 and a shape of the fourth guide groove g4 may be reversed from each other.

Attractive force may be applied between the holder 330 and the guide member 320. For example, a second pulling magnet 520 may be disposed on one of the holder 330 and the guide member 320, and a third pulling magnet 530 may be disposed on the other thereof.

In an example embodiment, the second pulling magnet 520 may be disposed on the guide member 320, and the third pulling magnet 530 may be disposed on the holder 330.

The second pulling magnet 520 and the third pulling magnet 530 may face each other in the first optical axis (Y-axis) direction.

In an example embodiment, the second pulling magnet 520 may be disposed on an upper surface of the guide member 320, and the third pulling magnet 530 may be disposed on a lower surface of the holder 330.

The second pulling magnet 520 may be disposed between the plurality of grooves of the third guide groove g3. Additionally, the third pulling magnet 530 may be disposed between the plurality of grooves of the fourth guide groove g4.

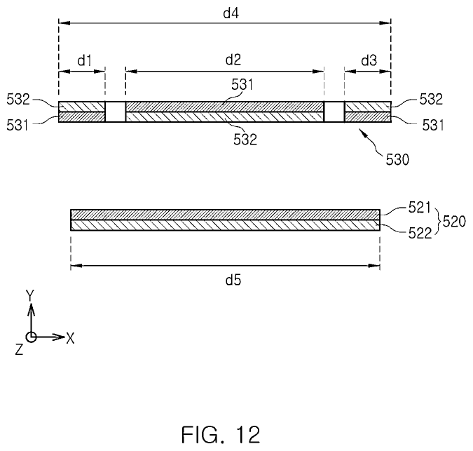

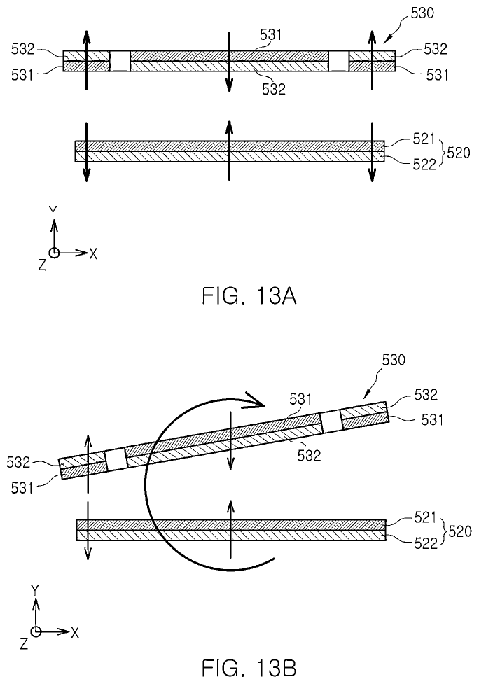

FIG. 12 is a cross-sectional view of the first pulling magnet and the second pulling magnet, and FIGS. 13A and 13B are views illustrating attractive force and repulsive force acting between the first pulling magnet and the second pulling magnet.

Both the attractive force and the repulsive force may be generated between the second pulling magnet 520 and the third pulling magnet 530. Additionally, a size of the attractive force between the second pulling magnet 520 and the third pulling magnet 530 may be greater than a size of the repulsive force between the second pulling magnet 520 and the third pulling magnet 530.

Accordingly, the second ball member B2 may remain in contact with the holder 330 and the guide member 320 by the attractive force between the second pulling magnet 520 and the third pulling magnet 530.

A length d4 of the third pulling magnet 530 in the first axis (X-axis) direction may be equal to or longer than a length d5 of the second pulling magnet 520 in the first axis (X-axis) direction.

When the holder 330 is rotated with the second optical axis (Z-axis) as the rotation axis, the third pulling magnet 530 coupled to the holder 330 is a movable member, and the second pulling magnet 520 coupled to the guide member 320 is a fixed member.

Accordingly, the length of the pulling magnet (the third pulling magnet 530 in this example embodiment) as the movable member in the first axis (X-axis) direction may be equal to or longer than the length of the pulling magnet (the second pulling magnet 520 in this example embodiment) as the fixed member in the first axis (X-axis) direction.

Both the attractive force and the repulsive force may be generated between the second pulling magnet 520 and the third pulling magnet 530. Here, a region in which the attractive force is generated is a central region in portions in which the second pulling magnet 520 and the third pulling magnet 530 face each other, and a region in which the repulsive force is generated may be an outer region in the portions in which the second pulling magnet 520 and the third pulling magnet 530 face each other.

The number of polarities on one surface of the second pulling magnet 520 and the number of polarities on one surface of the third pulling magnet 530 may be different from each other.

In an example embodiment, one surface of the second pulling magnet 520 (e.g., a surface facing the third pulling magnet 530) may be configured to have one polarity.

For example, one surface of the second pulling magnet 520 may have a first polarity 521, and the other surface (e.g., an opposite surface of the one surface) of the second pulling magnet 520 may have a second polarity 522. The first polarity 521 may be an N-pole or an S-pole, and the second polarity 522 may be a polarity opposite to the first polarity 521.

One surface of the third pulling magnet 530 (e.g., a surface facing the second pulling magnet 520) may be configured to have a plurality of polarities. That is, the one surface of the third pulling magnet 530 may have the plurality of polarities including opposite polarities formed therein.

For example, the one surface of the third pulling magnet 530 may have two first polarities 531 spaced apart from each other in the first axis (X-axis) direction, and a second polarity 532 disposed between the two first polarities 531. A boundary region may be disposed between the first polarity 531 and the second polarity 532. The boundary region may be a neutral region. The neutral region may extend in a direction parallel to the second optical axis (Z-axis).

The other surface (e.g., an opposite surface of the one surface) of the third pulling magnet 530 may have a polarity opposite to that of the one surface of the third pulling magnet 530.

On the one surface of the third pulling magnet 530, a length d2 of the second polarity 532 in the first axis (X-axis) direction may be equal to or longer than a sum (d1+d3) of lengths of the two first polarities 531 in the first axis (X-axis) direction.

On the one surface of the second pulling magnet 520 and the one surface of the third pulling magnet 530, an area in which the opposite polarities face each other may be greater than an area in which the same polarities faces each other.

Meanwhile, the length or the area of the first polarity 531 and the second polarity 532 may be measured by applying liquid iron to a surface of the third pulling magnet 530. For example, since the neutral region is disposed between the first polarity 531 and the second polarity 532, the liquid iron does not stick to the neutral region, but sticks only to portions having the first polarity 531 and the second polarity 532. Accordingly, the length or the area of the first polarity 531 and the second polarity 532 may be measured through a region to which the liquid iron sticks.

At least a portion of the two first polarities 531 on the one surface of the third pulling magnet 530 may face the first polarity 521 on the one surface of the second pulling magnet 520.

The second polarity 532 on the one surface of the third pulling magnet 530 may face the first polarity 521 on the one surface of the second pulling magnet 520.

Accordingly, attractive force is generated between the second polarity 532 of the one surface of the third pulling magnet 530 and the first polarity 521 of the one surface of the second pulling magnet 520. Additionally, repulsive force is generated between the two first polarities 531 of the one surface of the third pulling magnet 530 and the first polarity 521 of the one surface of the second pulling magnet 520.

A magnitude of the attractive force between the second pulling magnet 520 and the third pulling magnet 530 may be greater than a magnitude of the repulsive force between the second pulling magnet 520 and the third pulling magnet 530.

In the reflection module 300 according to an example embodiment of the present disclosure, not only the attractive force but also the repulsive force is generated between the second pulling magnet 520 and the third pulling magnet 530.

When a distance between the one side of the second pulling magnet 520 and the one side of the third pulling magnet 530 becomes relatively close due to the rotation of the holder 330, the repulsive force between the one side of the second pulling magnet 520 and the one side of the third pulling magnet 530 becomes stronger, so that the holder 330 may return to an original position when power is not applied to the reflection module 300.

Here, the original position may refer to a state in which the holder 330 is not rotated, for example, a state in which the second pulling magnet 520 and the third pulling magnet 530 are parallel to each other. For example, the original position may refer to a state in which the one surface of the second pulling magnet 520 and the one surface of the third pulling magnet 530 are substantially parallel to each other.

That is, the reflection module 300 according to an example embodiment of the present disclosure may reduce power consumption for setting a position of the holder 330 by mechanically implementing a centering structure of the holder 330.

Accordingly, when shake compensation is not required (e.g., when power is not supplied to the reflection module 300, or the like), the position of the holder 330 may be adjusted without separate power consumption.

Meanwhile, a generation structure of attractive force and repulsive force between the holder 330 and the guide member 320 may also be applied between the guide member 320 and the housing 100.

For example, the first pulling magnet 510 and the first pulling yoke 511 may be replaced with the second pulling magnet 520 and the third pulling magnet 530.

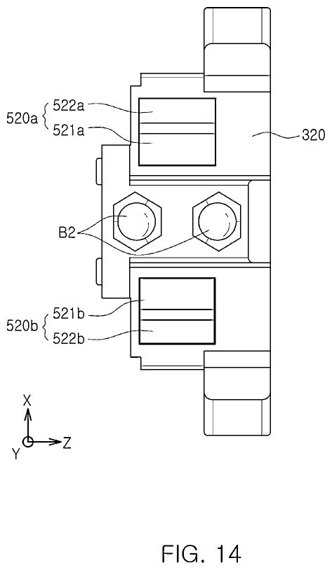

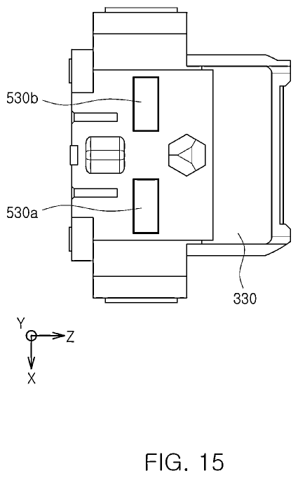

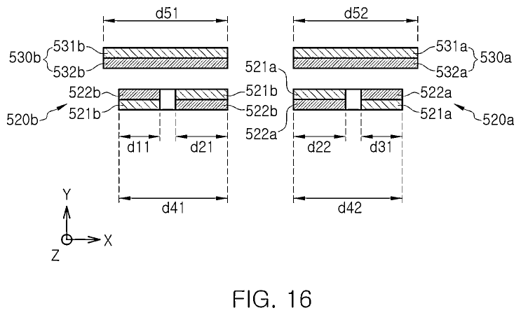

FIG. 14 is a plan view of a guide member and a second pulling magnet according to another example embodiment, and FIG. 15 is a bottom view of a holder and a third pulling magnet according to another example embodiment. Additionally, FIG. 16 is a cross-sectional view of a second pulling magnet and a third pulling magnet according to another example embodiment.

Referring to FIGS. 14 to 16, the second pulling magnet 520 may include a plurality of magnets spaced apart from each other in the first axis (X-axis) direction. In an example embodiment, the second pulling magnet 520 includes a second-first pulling magnet 520a and a second-second pulling magnet 520b. The second-first pulling magnet 520a and the second-second pulling magnet 520b may be spaced apart from each other in the first axis (X-axis) direction.

Additionally, the second-first pulling magnet 520a and the second-second pulling magnet 520b may be configured so that respective surfaces thereof have a plurality of polarities.

For example, one surface of the second-first pulling magnet 520a may be configured to have a first polarity 521a, a neutral region, and a second polarity 522a in the first axis (X-axis) direction.

On the one surface of the second-first pulling magnet 520a, a length of the first polarity 521a in the first axis (X-axis) direction and a length of the second polarity 522a in the first axis (X-axis) direction may be different from each other. For example, a length of the polarity formed to be closer to the second ball member B2 in the first axis (X-axis) direction may be formed to be longer.

The other surface of the second-first pulling magnet 520a may have a polarity opposite to that of the one surface of the second-first pulling magnet 520a.

One surface of the second-second pulling magnet 520b may be configured to have a first polarity 521b, a neutral region, and a second polarity 522b in the first axis (X-axis) direction.

On the one surface of the second-second pulling magnet 520b, a length of the first polarity 521b in the first axis (X-axis) direction and a length of the second polarity 522b in the first axis (X-axis) direction may be different from each other. For example, a length of the polarity formed to be closer to the second ball member B2 (or the second optical axis (Z-axis)) in the first axis (X-axis) direction may be formed to be longer.

The other surface of the second-second pulling magnet 520b may have a polarity opposite to that of the one surface of the second-second pulling magnet 520b.

The second-first pulling magnet 520a and the second-second pulling magnet 520b may be configured so that portions facing each other in the first axis (X-axis) direction have the same polarity.

A sum (d21+d22) of a length d22 of the first polarity 521a in the first axis (X-axis) direction, on the one surface of the second-first pulling magnet 520a, and a length d21 of the first polarity 521b in the first axis (X-axis) direction, on the one surface of the second-second pulling magnet 520b, may be equal to or longer than a sum (d11+d31) of a length d31 of the second polarity 522a in the first axis (X-axis) direction and a length d11 of the second polarity 522b in the first axis (X-axis) direction, on the one surface of the second-second pulling magnet 520b.

The third pulling magnet 530 may include a plurality of magnets spaced apart from each other in the first axis (X-axis) direction. In an example embodiment, the third pulling magnet 530 includes a third-first pulling magnet 530a and a third-second pulling magnet 530b. The third-first pulling magnet 530a and the third-second pulling magnet 530b may be spaced apart from each other in the first axis (X-axis) direction.

The second-first pulling magnet 520a and the third-first pulling magnet 530a may face each other in the first optical axis (Y-axis) direction, and the second-second pulling magnet 520b and the third-second pulling magnet 530b may face each other in the first optical axis (Y-axis) direction.

Additionally, the third-first pulling magnet 530a and the third-second pulling magnet 530b may be configured so that respective surfaces thereof have one polarity.

That is, the number of polarities on the one surface of the second-first pulling magnet 520a and the number of polarities on one surface of the third-first pulling magnet 530a facing each other may be configured differently. Additionally, the number of polarities on the one surface of the second-second pulling magnet 520b and the number of polarities on one surface of the third-second pulling magnet 530b facing each other may be configured differently.

For example, the one surface of the third-first pulling magnet 530a and the one surface of the third-second pulling magnet 530b may be configured to have a first polarity or a second polarity, respectively. Additionally, a polarity of the one surface of the third-first pulling magnet 530a and a polarity of the one surface of the third-second pulling magnet 530b may be the same.

In an example embodiment, the polarity of the one surface of the third-first pulling magnet 530a may be a polarity opposite to a polarity of the one surface of the second-first pulling magnet 520a, which is disposed closer to the second ball member B2 (or the second optical axis (Z-axis)). For example, when the first polarity 521a on the one surface of the second-first pulling magnet 520a is disposed closer to the second ball member B2 than the second polarity 522a, the one surface of the third-first pulling magnet 530a may have a second polarity 532a and the other surface of the third-first pulling magnet 530a may have the first polarity 531a.

Additionally, the polarity of the one surface of the third-second pulling magnet 530b may be a polarity opposite to a polarity of the one surface of the second-second pulling magnet 520b, which is disposed closer to the second ball member B2. For example, when the first polarity 521b on the one surface of the second-second pulling magnet 520b is disposed closer to the second ball member B2 than the second polarity 522b, the one surface of the third-second pulling magnet 530b may have the second polarity 532b and the other side of the third-second pulling magnet 530b may have a first polarity 531b.

In an example embodiment, the second pulling magnet 520 and the third pulling magnet 530 may be configured so that both attractive force and repulsive force are generated therebetween. For example, in the one surface of the second-first pulling magnet 520a and the one surface of the third-first pulling magnet 530a, the attractive force may be generated in a region relatively close to the second ball member B2, and the repulsive force may be generated in a region relatively far from the second ball member B2.

In an example embodiment, a sum (d51+d52) of a length d52 of the third-first pulling magnet 530a in the first axis (X-axis) direction and a length d51 of the third-second pulling magnet 530b in the first axis (X-axis) direction may be equal to or longer than a sum (d41+d42) of a length d42 of the second-first pulling magnet 520a in the first axis (X-axis) direction and a length d41 of the second-second pulling magnet 520b in the first axis (X-axis) direction.

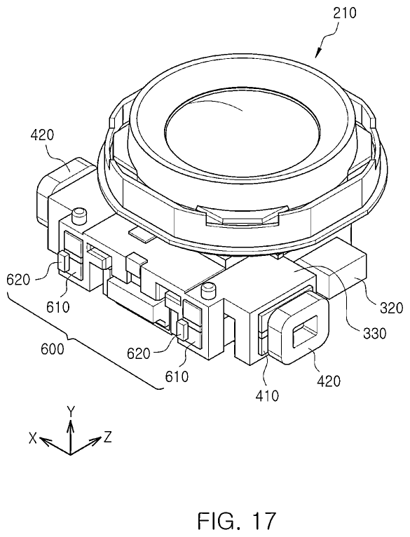

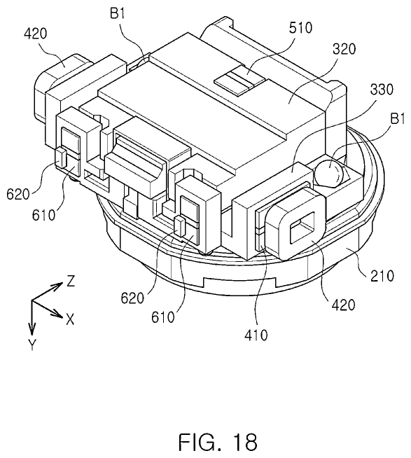

FIG. 17 is a perspective view of the reflection module and the first lens module, and FIG. 18 is a bottom perspective view of the reflection module and the first lens module.

In an example embodiment, the camera module 1 may sense positions of the guide member 320 and the holder 330. To this end, a position sensing unit 600 is provided. The position sensing unit 600 includes a sensing magnet 610 and a first position sensor 620.

The sensing magnet 610 may be disposed in the holder 330. For example, the sensing magnet 610 may be disposed on a rear surface of the holder 300. One surface of the sensing magnet 610 (for example, a surface facing the first position sensor 620) may be magnetized to have an N-pole, a neutral region, and an S-pole in the first optical axis (Y-axis) direction.

The first position sensor 620 may be disposed in a position facing the sensing magnet 610 (e.g., a position in which the first position sensor 620 and the sensing magnet 610 face each other in the second optical axis (Z-axis) direction). The first position sensor 620 may be disposed on the substrate 900.

In an original position, a neutral region of the sensing magnet 610 may face the first position sensor 620. Here, the original position may refer to a state in which the holder 330 and the guide member 320 are not rotated, respectively, for example, a state in which the second pulling magnet 520 and the third pulling magnet 530 are parallel to a bottom surface of the housing 100.

When the guide member 320 and the holder 330 are rotated about the first axis (X-axis) as the rotation axis, a distance between the sensing magnet 610 and the first position sensor 620 in the second optical axis (Z-axis) direction changes, through which a position of the guide member 320 may be sensed.

When the holder 330 is rotated about the second optical axis (Z-axis) as the rotation axis, a polarity area of the one surface of the sensing magnet 610 facing the first position sensor 620 changes, through which the position of the holder 330 may be sensed.

The first position sensor 620 may be a Hall sensor.

Meanwhile, the sensing magnet 610 may include a plurality of magnets spaced apart from each other in the first axis (X-axis) direction, and the first position sensor 620 may include a plurality of Hall sensors spaced apart from each other in the first axis (X-axis) direction.

When the sensing magnet 610 and the first position sensor 620 are provided in plural, the accuracy of position sensing may be improved.

In an example embodiment, a plurality of sensing magnets 610 may be spaced apart from each other. For example, the plurality of sensing magnets 610 may be spaced apart from each other in the first axis (X-axis) direction.

Additionally, a virtual line connecting the plurality of balls of the second ball member B2 to each other may be disposed between the plurality of sensing magnets 610. Distances from the virtual line connecting the plurality of balls of the second ball member B2 to each other to each of the sensing magnets 610 may be the same.

One surface (e.g., a surface facing the first position sensor 620) of each sensing magnet 610 may have an S-pole, a neutral region, and an N-pole in order, in a positive first optical axis (Y-axis) direction (+Y-axis direction). That is, polar magnet forms of the plurality of sensing magnets 610 may be the same.

Hereinafter, a sensing method of the position sensing unit 600 will be described when the polar magnet forms of the plurality of sensing magnets 610 are the same.

When the guide member 320 is rotated about the first axis (X-axis) as a rotation axis, the plurality of first position sensors 620 all move away from or become closer to the same polarity. For example, by rotation of the guide member 320, the plurality of first position sensors 620 may all move away from the N-pole and become closer to the S-pole, or the plurality of first position sensors 620 may all move away from the S-pole and become closer to the N-pole. Accordingly, signal values output from the plurality of first position sensors 620 have the same form.

When the guide member 320 is rotated about the first axis (X-axis) as the rotation axis, a position of the guide member 320 may be accurately sensed by summing signal values output from the plurality of first position sensors 620.

In the case in which the holder 330 is rotated about the second optical axis (Z axis) as a rotation axis, when one of the plurality of first position sensors 620 becomes closer to the N-pole and moves away from the S-pole, the other thereof may become closer to the S-pole and may move away from the N-pole. Accordingly, a signal value output from one of a plurality of first position sensors 620 and a signal value output from the other thereof may have different forms.

For example, when the signal value output from one of the plurality of first position sensors 620 is in the form of a right upward straight line, the signal value output from the other of a plurality of first position sensors 620 may be in the form of a right downward straight line. That is, graphs of the signal values output from the plurality of first position sensors 620 may be in the form of an X.

When the holder 330 is rotated about the second optical axis Z as the rotation axis, the position of the holder 330 may be accurately sensed by calculating a difference between the signal values output from the plurality of first position sensors 620.

In an example embodiment, one surface of one of a plurality of sensing magnets 610 may have an S-pole, a neutral region, and an N-pole in order in the positive first optical axis direction (+Y-axis direction). Additionally, one surface of the other of the plurality of sensing magnets 610 may have an N-pole, a neutral region, and an S-pole in order in the positive first optical axis direction (+Y-axis direction).

Hereinafter, a sensing method of the position sensing unit 600 will be described when polar magnet forms of the plurality of sensing magnets 610 are different from each other.

In the case in which the guide member 320 is rotated about the first optical axis (Y-axis) as a rotation axis, when one of the plurality of first position sensors 620 become close to the N-pole and moves away from the S-pole, the other thereof may become closer to the S-pole and move away from the N-pole. Accordingly, a signal value output from one of the plurality of first position sensors 620 and a signal value output from the other thereof may have different forms.

For example, when a signal value output from one of the plurality of first position sensors 620 is in a right upward straight line form, a signal value output from the other of the plurality of first position sensors 620 may be in a right downward line form. That is, graphs of signal values output from the plurality of first position sensors 620 may be in an X form.

When the guide member 320 is rotated about the first optical axis (X-axis) as the rotation axis, a position of the guide member 320 may be accurately sensed by calculating a difference between the signal values output from the plurality of first position sensors 620.

When the holder 330 is rotated about the second optical axis (Z axis) as the rotation axis, the plurality of first position sensors 620 all move away from or become close to the same polarity. For example, by rotation of the holder 330, the plurality of first position sensors 620 may all move away from the N-pole and become close to the S-pole, or the plurality of first position sensors 620 may all move away from the S-pole and become close to the N-pole. Accordingly, signal values output from the plurality of first position sensors 620 have the same form.

When the holder 330 is rotated about the second optical axis (Z-axis) as a rotation axis, a position of the holder 330 may be accurately sensed by summing the signal values output from the plurality of first position sensors 620.

The position sensing unit 600 may further include a controller. The controller may be a driver IC. In an example embodiment, the driver IC and the first position sensor 620 may be provided in the form of a single chip.

The position sensing unit 600 may control feedback of the signal values output from the plurality of first position sensors 620, and may apply power having an appropriate direction and magnitude to the first coil 420 so that the holder 330 and the guide member 320 may be disposed in a target position.

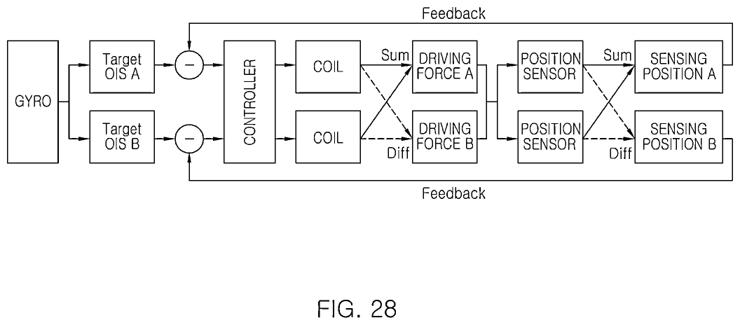

Referring to FIG. 28, the reflection module 300 may further include a gyro. The gyro may be a sensor for sensing a posture value of the holder 330. Alternatively, when the reflection module 300 does not include a gyro, a gyro mounted on a portable electronic device may be used. That is, since the reflection module 300 is mounted on the portable electronic device, an output value of the gyro mounted on the portable electronic device may be used.

A shake correction value may be calculated by the posture value output from the gyro (Target OIS A or Target OIS B), and when the shake correction value is input to the controller, current may be applied to at least one of the plurality of first coils 420 by the controller. Accordingly, the holder 330 may be rotated.

In FIG. 28, A may refer to one of rotation based on the first axis (X-axis) and rotation based on the second optical axis (Z-axis). Accordingly, when A refers to the rotation based on the first axis (X-axis), B may refer to the rotation based on the second optical axis (Z-axis).

For example, in FIG. 28, the target OIS A may be a target position of the holder 330 rotated based on the first axis (X-axis). The target OIS B may be a target position of the holder 330 rotated based on the second optical axis (Z-axis). Driving force A may refer to driving force for rotating the holder 330, based on the first axis (X-axis), and driving force B may refer to driving force for rotating the holder 330 based on the second optical axis (Z-axis). Sensing position A may refer to sensing a position of the holder 330 rotated based on the first axis (X-axis), and sensing position B may refer to sensing a position of the holder 330 rotated based on the second optical axis (Z-axis).

When the polar magnet forms of the plurality of first magnets 410 are the same, current in the same direction may be applied to the plurality of first coils 420, thus generating driving force so that the guide member 320 and the holder 330 may be rotated based on the first axis (X-axis). Additionally, current in opposite directions may be applied to the plurality of first coils 420, thus generating driving force so that the holder 330 may be rotated based on the second optical axis (Z-axis).

However, the present disclosure is not limited thereto, and the magnet shape of the polarities of the plurality of first magnets 410 and the current application direction of the plurality of first coils 420 for generating the driving force in one direction may be variously configured.

Meanwhile, the position of the holder 330 may be accurately sensed by summing the signal values output from the plurality of first position sensors 620. Additionally, the position of the holder 330 may be accurately sensed by calculating a difference on the signal values output from the plurality of first position sensors 620.

Furthermore, by controlling feedback on the signal values output from multiple first position sensors 620, power having an appropriate direction and size may be applied to the plurality of first coils 420 so that the holder 330 and the guide member 320 may be disposed in the target position.

Meanwhile, in an example embodiment of FIGS. 17 and 18, it has been described that the position sensing unit 600 includes the plurality of sensing magnets 610, but the position sensing unit 600 may also be configured to include only a plurality of first position sensors 620 without including the plurality of sensing magnets 610.

In this case, the plurality of first position sensors 620 may be disposed to face the plurality of first magnets 410, and may be disposed inside or outside of the plurality of first coils 420. A method of sensing the position of the holder 330 is the same as in the above-described embodiment.

In another example embodiment, a position of the first driver 400 and a position of the position sensing unit 600 may be changed with each other. For example, referring to FIG. 17, the first magnet 410 of the first driver 400 is disposed on both sides of the holder 330 spaced apart from each other in the first axis (X-axis) direction, and the sensing magnet 610 of the position sensing unit 600 is disposed on a rear surface of the holder 330, perpendicular to both sides of the holder 330.

When the position of the first driver 400 and the position of the position sensing unit 600 are changed with each other, the sensing magnet 610 of the position sensing unit 600 may be disposed on both sides of the holder 330 spaced apart from each other in the first axis (X-axis) direction, and the first magnet 410 of the first driver 400 may be disposed on the rear surface of the holder 330, perpendicular to both sides of the holder 330.

Meanwhile, a virtual line connecting the multiple balls of the first ball member B1 may overlap the neutral region of the sensing magnet 610 when viewed from the second optical axis (Z-axis) direction. Additionally, the virtual line connecting the plurality of balls of the first ball member B1 may overlap the first position sensor 620 when viewed from the second optical axis (Z-axis) direction.

A virtual line connecting the plurality of balls of the second ball member B2 may overlap the neutral region of the sensing magnet 610 when viewed from the first axis (X-axis) direction. Additionally, the virtual line connecting the plurality of balls of the second ball member B2 may overlap the first position sensor 620 when viewed from the first axis (X-axis) direction.

Meanwhile, although not illustrated in the drawings, a spacer may be disposed on a lower surface of the first lens module 210 (i.e., a lower surface of the first lens holder 212 facing the reflection member 310. The spacer has an entrance hole through which light passes, and the entrance hole may be non-circular. For example, the entrance hole may have a land track shape. That is, an inner surface of the spacer forming the entrance hole may include two planes extending parallel to each other, and two curved surfaces connecting the two planes.

The inner surface of the spacer may have a waveform in which concave and convex shapes are repeated, thereby preventing a flare phenomenon.

Meanwhile, referring to FIG. 4, the camera module 1 may include a first stopper 340. The first stopper 340 may be coupled to the housing 100 to cover at least a portion of the reflection module 300. For example, the first stopper 340 may cover at least a portion of an upper surface of the holder 330. The first stopper 340 and the holder 330 may be spaced apart from each other in the first optical axis (Y-axis) direction. Additionally, the first stopper 340 and the holder 330 may be spaced apart from each other in the second optical axis (Z-axis) direction.

Since the first stopper 340 is spaced apart from the reflection module 300, the reflection module 300 may be prevented from being separated from the housing 100 due to external impact or the like, without impeding the rotation of the reflection module 300.

A buffer member 341 having elasticity may be coupled to the first stopper 340. The buffer member 341 may be disposed on at least one of a first surface and a second surface of the first stopper 340. The first surface of the first stopper 340 may be a surface facing the case 110 in the first optical axis (Y-axis) direction, and the second surface of the first stopper 340 may be a surface facing the holder 330 in the first optical axis (Y-axis) direction.

Additionally, the buffer member 341 may also be disposed on a side surface of the first stopper 340. The side surface of the first stopper 340 may be a surface facing the holder 330 in the second optical axis (Z-axis) direction.

Meanwhile, a second stopper 350 may be coupled to the guide member 320 or the holder 330. In an example embodiment, the second stopper 350 may be fixed to the holder 330, and a portion of the second stopper 350 may extend toward the guide member 320. A coupling portion to which the second stopper 350 is coupled may be disposed on the holder 330. The coupling portion may be in a shape of a groove or a hole.

A receiving portion in which a portion of the second stopper 350 is received may be disposed on the guide member 320. The receiving portion may be in the shape of a groove or a hole.

The second stopper 350 may be fixed to the coupling portion of the holder 330, and a portion of the second stopper 350 may extend toward the guide member 320 and may be received in the receiving portion of the guide member 320.

A portion of the second stopper 350 may be spaced apart from the receiving portion. An end of a portion of the second stopper 350 may be bent and extended in the receiving portion. A portion of the second stopper 350 and the receiving portion of the guide member 320 may have shapes corresponding to each other.

In an example embodiment, an end of a portion of the second stopper 350 and the receiving portion may face each other in the first optical axis (Y-axis) direction.

Accordingly, the second stopper 350 may prevent the holder 330 from being separated from the guide member 320 due to external impact or the like, without impeding the rotation of the holder 330.

A buffer member 101 may be disposed on at least one of the surfaces on which the guide member 320 and the housing 100 face each other (for example, a surface facing the first lens module 210 in the first optical axis (Y-axis) direction).

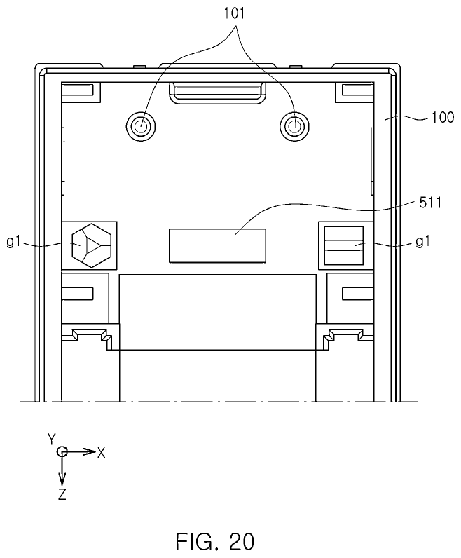

For example, referring to FIG. 20, the buffer member 101 having elasticity may be disposed on an inner bottom surface of the housing 100. The inner bottom surface of the housing 100 may be a surface facing the guide member 320 in the first optical axis (Y-axis) direction. As another example, the buffer member 101 may be disposed on a lower surface of the guide member 320 (a surface facing the inner bottom surface of the housing 100 in the first optical axis (Y-axis) direction).

Accordingly, when the guide member 320 rotates based on the first axis (X-axis), the rotation range may be limited, and when the guide member 320 and the housing 100 collide with each other, an impact amount and noise may be reduced.

The buffer member may be disposed on at least one of the surfaces on which the holder 330 and the first stopper 340 face each other (for example, a surface facing the first lens module 210 in the first optical axis (Y-axis) direction).

For example, referring to FIG. 7, a buffer member 331 may be disposed on an upper surface of the holder 330 (a surface facing a lower surface of the first stopper 340 in the first optical axis (Y-axis) direction). The buffer member 331 may be formed of an elastic material.

Accordingly, when the holder 330 rotates based on the second optical axis (Z-axis), the rotation range may be limited, and when the holder 330 and the first stopper 340 collide with each other, an amount of impact and noise may be reduced.

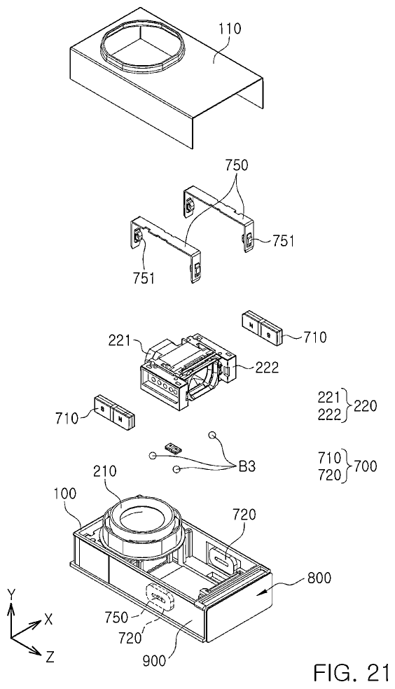

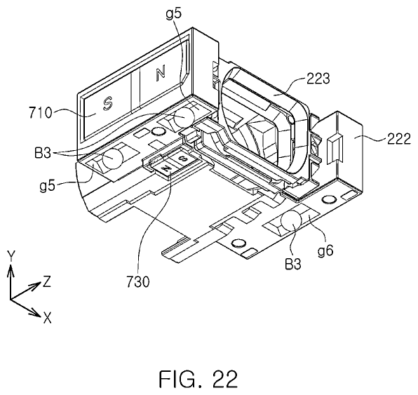

FIG. 21 is a perspective view illustrating a state in which a second lens module is separated from a camera module according to an example embodiment of the present disclosure, and FIG. 22 is a bottom perspective view of the second lens module.

Referring to FIG. 21, a second lens module 220 may be disposed between a reflection module 300 and an image sensor module 800.

The second lens module 220 may be moved in the second optical axis (Z-axis) direction for focus adjustment.

In an example embodiment, the second lens module 220 includes a second lens barrel 221 and a second lens holder 222. A plurality of lenses are disposed in the second lens barrel 221, and the second lens barrel 221 may be coupled to the second lens holder 222.

The camera module 1 may include a second driver 700 to move the second lens module 220 in the second optical axis (Z-axis) direction.

The second driver 700 includes a second magnet 710 and a second coil 720. The second magnet 710 and the second coil 720 may be disposed to face each other in a direction, perpendicular to the second optical axis (Z-axis) direction.

The second magnet 710 is mounted on the second lens module 220. For example, the second magnet 710 may be disposed on a side surface of the second lens module 220.

In an example embodiment, the second magnet 710 may include two magnets, and one magnet may be mounted on each of one side surface and the other side surface of the second lens module 220. The one side surface and the other side surface of the second lens module 220 may be spaced apart from each other in the first axis (X-axis) direction.

The second magnet 710 may be magnetized so that one surface thereof (e.g., a surface facing the second coil 720) has both an N-pole and an S-pole. For example, the one surface of the second magnet 710 facing the second coil 720 may be sequentially provided with an N-pole, a neutral region, and an S-pole in the second optical axis (Z-axis) direction.

The second coil 720 is disposed to face the second magnet 710. For example, the second coil 720 may be disposed to face the second magnet 710 in a direction, perpendicular to the second optical axis (Z-axis) direction (e.g., in the first axis (X-axis) direction).

The second coil 720 is disposed on the substrate 900, and the substrate 900 is mounted on the housing 100 so that the second magnet 710 and the second coil 720 face each other in the first axis (X-axis) direction. In an example embodiment, the second coil 720 may include two coils spaced apart from each other in the first axis (X-axis) direction.

The housing 100 is provided with a through-hole penetrating through the housing 100, and the second coil 720 disposed on the substrate 900 may directly face the second magnet 710 through the through-hole.

When adjusting the focus, the second magnet 710 is a moving member mounted on the second lens module 220 to move in the second optical axis (Z-axis) direction together with the second lens module 220, and the second coil 720 is a fixed member fixed to the substrate 900.

When power is applied to the second coil 720, the second lens module 220 may be moved in the second optical axis (Z-axis) direction by the electromagnetic force between the second magnet 710 and the second coil 720.

A third ball member B3 is disposed between the second lens module 220 and the housing 100, and the second lens module 220 may be guided by the third ball member B3 to move in the second optical axis (Z-axis) direction. The third ball member B3 includes a plurality of balls.

A fourth pulling magnet 730 is disposed on a lower surface of the second lens module 220, and a second pulling yoke may be disposed on the inner bottom surface of the housing 100. In another example embodiment, the fourth pulling magnet 730 may be disposed on both the second lens module 220 and the housing 100.

The fourth pulling magnet 730 may be disposed closer to one side surface of the second lens module 220. That is, the fourth pulling magnet 730 may be disposed closer to one side surface of the second lens module 220 than to the other side surface of the second lens module 220. Additionally, the fourth pulling magnet 730 may be disposed between one side surface of the second lens module 220 and the second optical axis (Z-axis).

The fourth pulling magnet 730 and the second pulling yoke may be disposed to face each other in the first optical axis (Y-axis) direction.

The fourth pulling magnet 730 and the second pulling yoke may generate attractive force between each other. For example, the attractive force is applied between the fourth pulling magnet 730 and the second pulling yoke in the first optical axis (Y-axis) direction.

By the attractive force of the fourth pulling magnet 730 and the second pulling yoke, the third ball member B3 may be in contact with the second lens module 220 and the housing 100, respectively.

Some of the plurality of balls of the third ball member B3 may be disposed close to one side surface of the second lens module 220, and the others of the plurality of balls of the third ball member B3 may be disposed close to the other side surface of the second lens module 220. The number of balls disposed between the one side surface of the second lens module 220 and the second optical axis (Z-axis) may be greater than the number of balls disposed between the other side surface of the second lens module 220 and the second optical axis (Z-axis).

In an example embodiment, the third ball member B3 may include at least three balls. When three balls are disposed, two of the three balls may be disposed between the one side surface of the second lens module 220 and the second optical axis (Z-axis), and the remaining one of the three balls may be disposed between the other side surface of the second lens module 220 and the second optical axis (Z-axis).

The two balls disposed between the one side surface of the second lens module 220 and the second optical axis (Z-axis) may be spaced apart from each other in the second optical axis (Z-axis) direction.

A fifth guide groove g5 and a sixth guide groove g6 may be disposed on at least one of the surfaces on which the second lens module 220 and the housing 100 face each other. For example, the fifth guide groove g5 may be disposed on one side of the lower surface of the second lens module 220, and the sixth guide groove g6 may be disposed on the other side of the lower surface of the second lens module 220.

The fifth guide groove g5 and the sixth guide groove g6 may be spaced apart from each other in a direction, perpendicular to the second optical axis (Z-axis) (for example, the first axis (X-axis) direction).

The fifth guide groove g5 and the sixth guide groove g6 extend in a direction, parallel to the second optical axis (Z-axis).

Some of the plurality of balls of the third ball member B3 are disposed in the fifth guide groove g5, and the others of the plurality of balls of the third ball member B3 are disposed in the sixth guide groove g6.

The number of contact points between some of the plurality of balls of the third ball member B3 and the fifth guide groove g5 is greater than the number of contact points between the others of the plurality of balls of the third ball member B3 and the sixth guide groove g6.

The fifth guide groove g5 is disposed closer to the one side surface of the second lens module 220 than the sixth guide groove g6.

The fourth pulling magnet 730 may be disposed closer to the fifth guide groove g5 than the sixth guide groove g6.

In an example embodiment, the camera module 1 may sense a position of the second lens module 220. To this end, a second position sensor 750 is provided. The second position sensor 750 may be disposed in a position facing the second magnet 710 of the second driver 700 (for example, a position facing in the first axis (X-axis) direction).

Accordingly, when the second lens module 220 moves in the second optical axis (Z-axis) direction, the position of the second lens module 220 may be sensed through the second position sensor 750.

The second position sensor 750 may be a Hall sensor.

Meanwhile, the second lens module 220 may further include a light shield (shading plate) 223. The light shield 223 may be coupled to the second lens module 220.

The one side surface and the other side surface of the second lens module 220 may be formed to extend from the second lens module 220 in the second optical axis (Z-axis) direction, respectively. A portion of the one side surface of the second lens module 220 and a portion of the other side surface of the second lens module 220 may face each other in the first axis (X-axis) direction. A space may be formed between a portion of the one side surface of the second lens module 220 and a portion of the other side surface of the second lens module 220.

The shading plate 223 may be disposed in a space between a portion of the one side surface of the second lens module 220 and a portion of the other side surface of the second lens module 220.

The shading plate 223 serves to prevent light passing through the second lens module 220 from causing unintended reflection in the housing 100. Accordingly, a flare phenomenon may be suppressed.

The camera module 1 may further include a third stopper 750. The third stopper 750 may be coupled to the housing 100 and may cover at least a portion of the second lens module 220.

In an example embodiment, the third stopper 750 may be disposed so as to face an upper surface of the second lens module 220 in the first optical axis (Y-axis) direction. One side and the other side of the third stopper 750 may be bent and extended in the first optical axis (Y-axis) direction to face the second lens module 220 in the second optical axis (Z-axis) direction, respectively.

A buffer member 751 having elasticity may be coupled to the third stopper 750. For example, the buffer member 751 may be mounted on the one side and the other side of the third stopper 750 facing the second lens module 220 in the second optical axis (Z-axis) direction, respectively.

Additionally, a buffer member may be mounted on at least one of the surfaces on which the third stopper 750 and the second lens module 220 face each other in the first optical axis (Y-axis) direction.

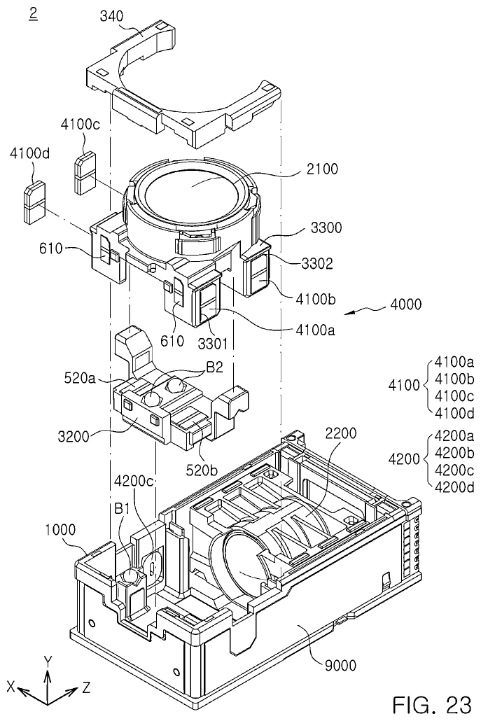

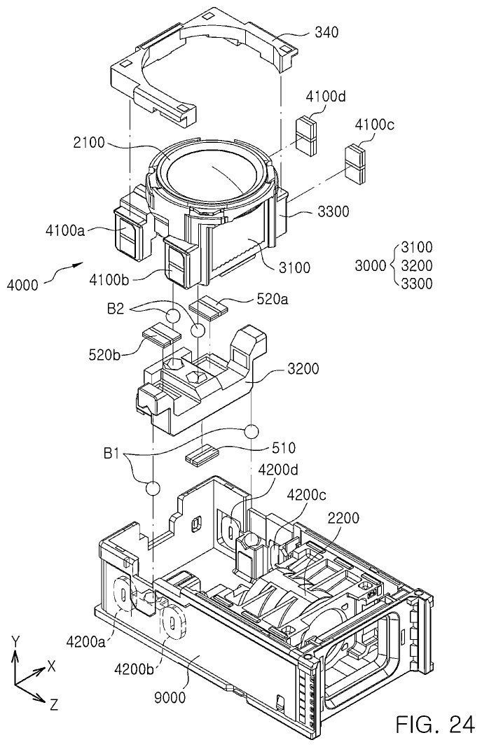

FIG. 23 is an exploded perspective view of a camera module according to another example embodiment of the present disclosure, and FIG. 24 is an exploded perspective view of a camera module viewed from a direction different from that of FIG. 23.

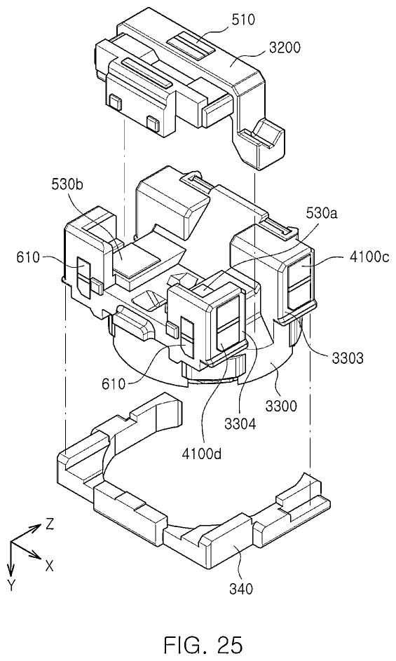

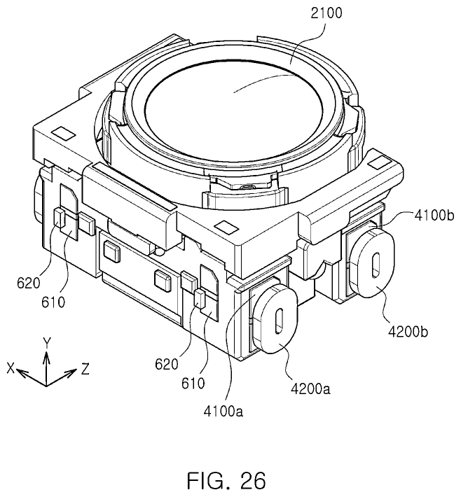

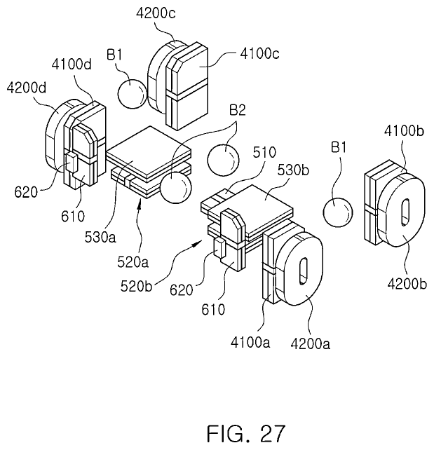

Additionally, FIG. 25 is a bottom perspective view of a reflection module according to another example embodiment of the present disclosure, FIG. 26 is a perspective view of a reflection module and a first lens module according to another example embodiment of the present disclosure, and FIG. 27 is a perspective view of a first driver, a first ball member, a second ball member, a first pulling magnet and a second pulling magnet according to another example embodiment of the present disclosure.

Referring to FIGS. 23 to 27, a camera module 2 according to another example embodiment of the present disclosure includes a reflection module 3000 and a housing 1000, and may further include a first lens module 2100.

The first lens module 2100 may be coupled to the reflection module 3000. For example, the first lens module 2100 may be coupled to a holder 3300 of the reflection module 3000.

In an example embodiment, the camera module 2 may further include a second lens module 2200. The reflection module 3000 is disposed between the first lens module 2100 and the second lens module 2200.

The first optical axis (Y-axis) of the first lens module 2100 and the second optical axis (Z-axis) of the second lens module 2200 may be formed to be perpendicular to each other.

The first lens module 2100 includes one or more lenses, and the second lens module 2200 includes a plurality of lenses.

The first lens module 2100 and the reflection module 3000 may be configured to rotate together for shake correction. The second lens module 2200 may be moved in the second optical axis (Z-axis) direction for focus adjustment.

The reflection module 3000 includes a reflection member 3100, the holder 3300, and a guide member 3200.

The reflection member 3100 has a reflection surface reflecting light passing through the first lens module 2100. For example, the reflection member 3100 may be a prism or a mirror.

The reflection member 3100 is mounted on the holder 3300. The first lens module 2100 may be disposed in front of the reflection member 3100. In an example embodiment, the first lens module 2100 may be mounted in the holder 3300.

The holder 3300 is rotatably disposed in the guide member 3200. Additionally, the guide member 3200 is rotatably disposed on the housing 1000.

The guide member 3200 may be rotatable about the first axis (X-axis), perpendicular to both the first optical axis (Y-axis) and the second optical axis (Z-axis), as a rotation axis. For example, the guide member 3200 may be relatively rotatable on the housing 1000 about the first axis (X-axis) as a rotation axis. In this regard, the first lens module 2100 and the holder 3300 may also be rotated together with the guide member 3200. Meanwhile, the first axis (X-axis) may also be referred to as the first rotation axis.

The holder 3300 may be rotatable about the second optical axis (Z-axis), perpendicular to the first axis (X-axis), as the rotation axis. For example, the holder 3300 may be relatively rotatable on the guide member 3200 about the second optical axis (Z-axis) as the rotation axis. In this case, the first lens module 2100 may be rotated together with the holder 3300. Meanwhile, the second optical axis (Z-axis) may also be referred to as the second rotation axis.

A first driver 4000 may be provided to rotate the reflection module 3000. The first driver 4000 includes a first magnet 4100 and a first coil 4200.

The guide member 3200 may be relatively rotatable on the housing 1000 based on the first axis (X-axis) by the first driver 4000. Since the holder 3300 and the first lens module 2100 are disposed on the guide member 3200, the holder 3300 and the first lens module 2100 may also be rotated together with the guide member 3200.

The holder 3300 may be relatively rotatable on the guide member 3200 based on the second optical axis (Z-axis) by the first driver 4000. Since the first lens module 2100 is disposed on the holder 3300, the first lens module 2100 may also be rotated together with the holder 3300.

The first magnet 4100 may be mounted on the holder 3300. For example, the first magnet 4100 may be mounted on a side surface of the holder 3300.

The first magnet 4100 includes a plurality of magnets. For example, the first magnet 4100 may include a first-first magnet 4100a, a first-second magnet 4100b, a first-third magnet 4100c, and a first-fourth magnet 4100d.

The holder 3300 includes a first side surface 3301, a second side surface 3302, a third side surface 3303, and a fourth side surface 3304. The first side surface 3301 and the second side surface 3302 may be surfaces disposed on one side based on the second optical axis (Z-axis), and the third side surface 3303 and the fourth side surface 3304 may be surfaces disposed on the other side based on the second optical axis (Z-axis).

The first side surface 3301 and the second side surface 3302 are spaced apart from each other in the second optical axis (Z-axis) direction, and the third side surface 3303 and the fourth side surface 3304 are spaced apart from each other in the second optical axis (Z-axis) direction.

Additionally, the first side surface 3301 and the fourth side surface 3304 are spaced apart from each other in the first axis (X-axis) direction, and the second side surface 3302 and the third side surface 3303 are spaced apart from each other in the first axis (X-axis) direction.

The first-first magnet 4100a may be disposed on the first side surface 3301 of the holder 3300, the first-second magnet 4100b may be disposed on the second side surface 3302 of the holder 3300, the first-third magnet 4100c may be disposed on the third side surface 3303 of the holder 3300, and the first-fourth magnet 4100d may be disposed on the fourth side surface 3304 of the holder 3300.

The first ball member B1 may be disposed between the first side surface 3301 and the second side surface 3302 of the holder 3300, and between the third side surface 3303 and the fourth side surface 3304.

The first coil 4200 includes a plurality of coils. For example, the first coil 4200 may include a first-first coil 4200a facing the first-first magnet 4100a, a first-second coil 4200b facing the first-second magnet 4100b, a first-third coil 4200c facing the first-third magnet 4100c, and a first-fourth coil 4200d facing the first-fourth magnet 4100d.

The first coil 4200 may be disposed on a substrate 9000.

When power is applied to the first driver 4000, the first driver 4000 may generate driving force required for rotation of the holder 3300 and the guide member 3200 with the first axis (X-axis) as the rotation axis, and may generate driving force required for rotation of the holder 3300 with the second optical axis (Z-axis) as the rotation axis. For example, the first driver 4000 may rotate the holder 3300 and the guide member 3200 by adjusting the driving force of four pairs of magnets and coils.

In an example embodiment, among the four pairs of magnets and coils, the directions of the driving forces of the magnets and coils that are diagonally spaced apart from each other may be opposite to each other. For example, the first-first coil 4200a and the first-third coil 4200c may be connected to each other in series. Accordingly, a direction of the driving force between the first-first magnet 4100a and the first-first coil 4200a and a direction of the driving force between the first-third magnet 4100c and the first-third coil 4200c may be formed to be opposite to each other.

However, the coils disposed in the diagonal direction do not necessarily have to be connected in series, and may also be individually controlled.

When the direction of the driving force generated by the first-first magnet 4100a and the first-first coil 4200a is a positive first optical axis (Y-axis) direction (+Y-axis direction), a direction of the driving force generated by the first-third magnet 4100c and the first-third coil 4200c disposed in the diagonal direction may be a negative first optical axis (Y-axis) direction (−Y-axis direction).

When the direction of the driving force generated by the first-second magnet 4100b and the first-second coil 4200b is the positive first optical axis (Y-axis) direction (+Y-axis direction), the direction of the driving force generated by the first-fourth magnet 4100d and the first-fourth coil 4200d disposed in the diagonal direction may be the negative first optical axis (Y-axis) direction (−Y-axis direction).

Meanwhile, the sensing method of the position of the holder 3300 and the guide member 3200 is the same as the above-described example embodiment, and thus a detailed description thereof will be omitted.

According to an example embodiment of the present disclosure, a reflection module and a camera module including the same may enable a reflection member to be disposed in an original position thereof when power is not applied.

Additionally, according to an example embodiment of the present disclosure, a structure of a driver may be simplified to reduce a size and weight thereof.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a guide member disposed in the housing;
a holder disposed on the guide member;
a first driver including a first magnet disposed in the holder and a first coil facing the first magnet; and
a position sensing unit including a plurality of sensing magnets disposed in the holder and a plurality of first position sensors facing the plurality of sensing magnets,
wherein the guide member and the holder are rotatable relative to the housing by the first driver, and
wherein the holder is rotatable relative to the guide member by the first driver.

2. The camera module according to claim 1,
wherein one surface of each of the plurality of sensing magnets has an N-pole, a neutral region, and an S-pole,
polar arrangement forms of the one surface of each of the plurality of sensing magnets is the same, and
the position sensing unit is configured to,
generate a position signal of the guide member by summing signal values output from the plurality of first position sensors, and
generate a position signal of the holder by calculating a difference between signal values output from the plurality of first position sensors.

3. The camera module according to claim 1,
wherein one surface of each of the plurality of sensing magnets has an N-pole, a neutral region, and an S-pole,
positions of the N-pole and the S-pole of one of the plurality of sensing magnets and positions of the N-pole and the S-pole of the other thereof are opposite to each other, and
the position sensing unit is configured to,
generate a position signal of the guide member by calculating a difference between signal values output from the plurality of first position sensors, and
generate a position signal of the holder by summing signal values output from the plurality of first position sensors.

4. The camera module according to claim 1,
wherein a first pulling magnet is disposed on one of the guide member and the holder,
wherein a second pulling magnet facing the first pulling magnet is disposed on the other of the guide member and the holder, and
wherein both attractive force and repulsive force are applied between the first pulling magnet and the second pulling magnet.

5. The camera module according to claim 4,
wherein the guide member is rotatable based on a first rotation axis,
the holder is rotatable based on a second rotation axis,
the plurality of first position sensors face the plurality of sensing magnets in a direction of the second rotation axis, and
the first pulling magnet and the second pulling magnet face each other in a direction perpendicular to both the first rotation axis and the second rotation axis.

6. The camera module according to claim 5,
wherein the plurality of sensing magnets are spaced apart from each other in a direction of the first rotation axis,
a virtual line extending in the second rotation axis is disposed between the plurality of sensing magnets, and
a distance between each of the sensing magnets from the virtual line extending in the second rotation axis is the same.

7. The camera module according to claim 5,
wherein the first magnet includes two magnets, and the two magnets are disposed separately on one surface and another surface of the holder spaced apart from each other in a direction of the first rotation axis,
wherein the first driver is spaced apart from the first rotation axis in a direction of the second rotation axis, and
wherein the first driver is spaced apart from the second rotation axis in the direction of the first rotation axis.

8. The camera module according to claim 4,
wherein one surface of the first pulling magnet and one surface of the second pulling magnet face each other, and
wherein a number of polarities of the one surface of the first pulling magnet and a number of polarities of the one surface of the second pulling magnet are different from each other.

9. The camera module according to claim 8,
wherein an area in which opposite polarities face each other is greater than an area in which same polarities face each other, on the one surface of the first pulling magnet and the one surface of the second pulling magnet.

10. The camera module according to claim 5,
wherein one surface of the first pulling magnet and one surface of the second pulling magnet face each other,
wherein the one surface of the first pulling magnet has one polarity, and
wherein the one surface of the second pulling magnet has a plurality of polarities including opposite polarities.

11. The camera module according to claim 10,
wherein the one surface of the second pulling magnet has two first polarities spaced apart from each other and a second polarity disposed between the two first polarities,
wherein the first polarity is a same polarity as the one polarity of the one surface of the first pulling magnet,
wherein the first polarity and the second polarity are opposite polarities,
wherein a length of the second polarity is equal to or longer than a sum of lengths of the two first polarities, and
wherein the length is a length in a direction of the first rotation axis.

12. The camera module according to claim 5,
wherein among the first pulling magnet and the second pulling magnet, a length of the pulling magnet mounted on the holder is equal to or longer than a length of the pulling magnet mounted on the guide member, and
wherein the length is a length in a direction of the first rotation axis.

13. The camera module according to claim 5,
wherein the first pulling magnet includes a first-first pulling magnet and a first-second pulling magnet spaced apart from each other in a direction of the first rotation axis,
wherein the second pulling magnet includes a second-first pulling magnet facing the first-first pulling magnet and a second-second pulling magnet facing the first-second pulling magnet,
wherein both attractive force and repulsive force are applied between the first-first pulling magnet and the second-first pulling magnet, and
wherein both attractive forces and repulsive forces are applied between the first-second pulling magnet and the second-second pulling magnet.

14. The camera module according to claim 13,
wherein a number of polarities of one surface of the first-first pulling magnet and a number of polarities of one surface of the second-first pulling magnet facing each other are different from each other, and
wherein a number of polarities of one surface of the first-second pulling magnet and a number of polarities of one surface of the second-second pulling magnet facing each other are different from each other.

15. The camera module according to claim 14,
wherein the one surface of the first-first pulling magnet and the one surface of the first-second pulling magnet have a first polarity and a second polarity, respectively, and the one surface of the second-first pulling magnet and the one surface of the second-second pulling magnet have a first polarity or a second polarity, respectively, and
wherein the first polarity and the second polarity are opposite polarities.

16. The camera module according to claim 15,
wherein among the first polarity and the second polarity of the one surface of the first-first pulling magnet, a length of a polarity disposed closer to the second rotation axis is equal to or longer than a length of the other polarity,
wherein among the first polarity and the second polarity of the one surface of the first-second pulling magnet, a length of a polarity disposed closer to the second rotation axis is equal to or longer than a length of the other polarity, and
wherein the length is a length in a direction of the first rotation axis.

17. The camera module according to claim 5, further comprising:
a first lens module having a first optical axis and coupled to the holder,
wherein the first optical axis is perpendicular to the first rotation axis and the second rotation axis.

18. The camera module according to claim 5,
wherein a first ball member including a plurality of balls is disposed between the guide member and the holder, and the plurality of balls of the first ball member are spaced apart from each other in the direction of the second rotation axis, and
wherein a second ball member including a plurality of balls is disposed between the guide member and the housing, and the plurality of balls of the second ball member are spaced apart from each other in a direction of the first rotation axis.
